(19) United States
(12) Patent Application Publication
(10) Pub. No.: US 2010/0002628 A1
(43) Pub. Date: Jan. 7, 2010

(54) METHOD, APPARATUS AND COMMUNICATION NETWORK FOR THE TRANSMISSION OF DATA

(75) Inventors: Shlomi Anchi, Petakh-Tikva (IL); Aviv Barkan, Bat-Hefer (IL); Danny Zadok, Rishon-Lezion (IL)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 12/439,097

(22) PCT Filed: Aug. 23, 2007
(86) PCT No.: PCT/US07/76591

§ 371 Date: Feb. 26, 2009

(30) Foreign Application Priority Data
Aug. 29, 2006 (GB) 0616972.6

(51) Int. Cl. H04W 40/00

(52) U.S. Cl. 370/328

(57) ABSTRACT

A method of transmitting packets (200) of data across a network is described, where at least one packet of data comprises a header and a payload. The method comprises performing payload compression (210, 220) on the payload; performing header compression (230, 240) on the header; encapsulating the compressed header and payload within a transmission header (250) to create a transmission data packet (200); and transmitting the transmission data packet (200) across the network.

### FIELD OF THE INVENTION

This invention relates to a method, apparatus and communication network for the transmission of data. The invention is applicable to, but not limited to mobile computing devices.

### BACKGROUND OF THE INVENTION

In the field of this invention, it is known that the use of mobile computing devices, such as laptop/notebook computers, personal digital assistants (PDAs), mobile phones, etc. is becoming an increasingly important part of everyday life. This is particularly true for people working away from an office or corporate location, whether such people are working from home, or on the move.

Whilst such mobile computing devices are capable of providing considerable resources and functionality to a user in isolation, it is still often necessary for a device to be able to connect to, for example, resources on an enterprise/corporate network to upload and/or download data, information, etc.

The Internet has become a popular means of providing a connection between remote devices. The transport communication protocol/Internet Protocol (TCP/IP) suite establishes the technical foundation of the Internet. As is well known in the art, data transfers made using the TCP/IP protocol split data up into packets. Each packet is encapsulated within a header, which provides, amongst other elements, source address, destination address, checksums, etc.

It is also known to use virtual private networks (VPNs) as a means of providing a connection between, for example, enterprise networks and remote devices, such as mobile computing devices.

A VPN is, in effect, a private data network that makes use of a public telecommunication infrastructure, such as the Internet, maintaining privacy through the use of a tunnelling protocol and security procedures. A virtual private network can be contrasted with a system of owned or leased lines that can only be used by one company. The main purpose of a VPN is to provide the company the same capabilities as private leased lines at much lower cost by using the shared public infrastructure.

Internet Protocol Security (IPSec), the most widely deployed VPN technology, provides a set of authentication and encryption protocols developed by the Internet Engineering Task Force (IETF), to address data confidentiality, integrity, authentication, and key management in Internet protocol (IP) networks. Further information regarding IPSec can be found in RFC 2401 and RFC 2411 request for comments documents, managed by the IETF, at www.ietf.org.

The IPSec protocol typically works on the edges of a security domain, which encapsulates a packet, such as a TCP/IP packet, by wrapping another packet around it. It then encrypts the entire packet. This encrypted stream of traffic forms a secure tunnel across an otherwise unsecured IP network.

With the advent of packet based mobile data applications and the increase of wireless computing, there is a corresponding need for seamless communication between the mobile device and the packet data network (PDN), such as the Internet.

Mobile IP (MIP) is another standard developed by the IETF, and defined in RFC 3344. MIP allows users with mobile devices whose IP addresses are associated with one network to stay connected when moving to a network with a different IP address.

When a user leaves the network with which his device is associated (home network) and enters the domain of a foreign network, the foreign network uses the Mobile IP protocol to inform the home network of a care-of-address (CoA) to which all packets for the user's device should be sent.

To accomplish this, Mobile IP establishes the visited network as a foreign node or “agent” and the home network as the home node or “agent”. Mobile IP uses a tunnelling protocol to allow messages from the PDN to be directed to the mobile agent's IP address.

This is achieved by way of routing messages to the foreign agent for delivery via tunnelling the original IP address inside a packet destined for the temporary IP address assigned to the mobile device, known as the MIP Client, by the foreign agent. The home agent and foreign agent continuously advertise their services on the network through an Agent Discovery process, enabling the home agent to recognize when a new foreign agent is acquired and allowing the mobile device to register a new Care of Address.

Referring now to FIG. 1, there is illustrated a typical MIP data packet 100 as is known in the art.

The MIP data packet comprises user data 110. The user data 10 has been encapsulated within a TCP header 120, and then encapsulated within an IP header 130, to create a TCP/IP data packet 140.

As is well known in the art, the TCP/IP protocol suite is managed by the Internet Engineering Task Force, and has become a popular means of providing a connection between remote devices. It effectively establishes the technical foundation of the Internet.

Further information regarding the TCP/IP protocol may be obtained from the relevant Request For Comments (RFC) documents available at www.ietf.org.

Referring back to FIG. 1, the TCP/IP data packet is encapsulated within a Virtual private network (VPN) header 150, to create a VPN data packet 160. The VPN data packet 160 is encapsulate within a MIP header 170 to create the MIP data packet 100.

Thus, when a mobile device sends/receives data in such a manner, the data is encapsulated three times. First, the data is broken up and encapsulated within TCP/IP packets. The TCP/IP packets are then encapsulated within VPN (e.g. IPSec) headers, and then within MIP headers. Thus, each packet of data is encapsulated within three headers, thereby substantially increasing the amount of information that is required to be transmitted.

As will be appreciated, it is often the case that a mobile device operates in a hybrid network. Such a network comprises several links of different types. Each link may be private, public, wired, or wireless. Furthermore, each link may have different characteristics in terms of bandwidth, delay and error rate.

In such an environment, it is necessary to achieve as high a throughput as possible. In order to increase the throughput of the network, it is necessary to reduce the overheads of the various protocols used. By compressing the headers and the data (payload), performance can be improved due to less data to transfer, and thereby less chance of collision and re-transmission due to fewer data transfers.

IP Header compression and IP payload compression are two standard IP compression techniques.

Common IP header compression techniques are defined in RFC 2507 and RFC 2508. These methods rely on the Van-Jacobson algorithm, which states that an IP flow, going from point ‘A’ to point ‘B’ does not necessarily need to contain the entire IP header in each packet. Rather, point ‘B’ can use a previously received IP packet (originated by ‘A’), to deduce those header fields that remain constant within that flow (IP addresses, transport port numbers, etc.).

A problem with a header-compressed packet is that not all packets will contain source and destination addresses, since this information will be consistent throughout an IP flow. Therefore, IP header compression requires a receiver and transmitter to be located one link away from each other. Consequently, header compressed packets cannot be routed through a network.

To overcome this problem of the need for the receiver and transmitter to be located one link away, IP payload compression is used.

The essence of payload compression is the compression of the payload segment of an IP packet, as proposed in RFC 2393. The key difference between the various approaches is the compression algorithm used by each of them. Examples of such algorithms include the DEFLATE algorithm, defined in RFC 2394, and the LZS algorithm, defined in RFC 2395.

A problem with payload compression is that the algorithms used in this approach tend to have variant compression ratios, depending on the nature of the data. Thus, payload compression does not provide optimum compression.

There is therefore a need for an improved method of, and apparatus for, and communication network, transmitting data between mobile devices, through a network.

### SUMMARY OF THE INVENTION

In accordance with a first aspect of the present invention, there is provided a method of transmitting data packets, as claimed in Claim 1.

In accordance with a second aspect of the present invention, there is provided a method of receiving packets of data, as claimed in Claim 10.

In accordance with a third aspect of the present invention, there is provided apparatus adapted to perform a method of transmitting data packets, as claimed in Claim 19.

In accordance with a forth aspect of the present invention, there is provided apparatus adapted to perform a method of receiving data packets, as claimed in Claim 23.

In accordance with a fifth aspect of the present invention, there is provided a transmission data packet, as claimed in Claim 27.

In accordance with a sixth aspect of the present invention, there is provided a communication network, as claimed in Claim 28.

In accordance with a seventh aspect of the present invention, there is provided a communication network, as claimed in Claim 29.

Further aspects of the present invention are as claimed in the dependent claims.

### BRIEF DESCRIPTION OF THE DRAWINGS

Exemplary embodiments of the present invention will now be described, by way of example only, with reference to the accompanying drawings, in which:

FIG. 1 illustrates an uncompressed transmission data packet as is known in the art.

FIG. 2 illustrates a transmission data packet according to an embodiment of the present invention.

FIG. 3 illustrates an exemplary embodiment of a mobile device connecting to a remote server.

FIG. 4 illustrates a flow chart of a method of transmitting packets of data according to an embodiment of the present invention.

FIG. 5 illustrates a flow chart of a method of receiving packets of data according to an embodiment of the present invention.

FIG. 6 illustrates an alternative example of an uncompressed transmission data packet as is known in the art.

FIG. 7 illustrates a transmission data packet according to an alternative embodiment of the present invention.

FIG. 8 illustrates a flow chart of a method of transmitting packets of data according to an alternative embodiment of the present invention.

FIG. 9 illustrates a flow chart of a method of receiving packets of data according to an alternative embodiment of the present invention.

### DESCRIPTION OF EMBODIMENTS OF THE INVENTION

In one embodiment of the present invention, a method of transmitting packets of data across a network is described. At least one packet of data comprises a header and a payload. The method comprises performing payload compression on the payload; performing header compression on the header; encapsulating the compressed header and payload within a transmission header to create a transmission data packet; and transmitting the transmission data packet across the network.

The provision of performing separate payload compression on the payload and header compression on the header, and encapsulating the compressed header and payload within a transmission header to create a transmission data packet, provides at least the advantage of reducing the overheads required in transmitting data across a network. Consequently, an improvement in throughput of a communication network may be achieved.

In one embodiment of the present invention, the payload compression may be performed prior to header compression. The at least one packet of data to be transmitted may be a virtual private network (VPN) data packet, for example an IPSec data packet. The transmission header may be a Mobile IP (MIP) header, and the transmission data packet may be transmitted across the network via a MIP tunnel.

In one embodiment of the present invention, the at least one packet of data to be transmitted may be a TCP/IP data packet. The transmission header may be a Mobile virtual private network (MVPN) header, and the transmission data packet may be transmitted across the network via a MVPN tunnel.

In one embodiment of the present invention, the transmission header may contain an indication of the encapsulated transmission payload.

In one embodiment of the present invention, a method of transmitting data packets across a network is described. The method comprises receiving at least one TCP/IP data packet to be transmitted; encapsulating the at least one TCP/IP data packet within a VPN header to create a VPN packet, the TCP/IP data packet becoming at least a part of a payload of the VPN packet; performing payload compression on the VPN payload; performing header compression on the VPN header; encapsulating the VPN packet within a MIP header to create a MIP packet; and transmitting the MIP packet across the network via a MIP tunnel.

In one embodiment of the present invention, a method of transmitting data packets across a network is described. The method comprises receiving at least one TCP/IP data packet to be transmitted; performing payload compression on the TCP/IP payload; performing header compression on the TCP/IP header; encapsulating the TCP/IP packet within a MVPN header to create a MVPN packet; and transmitting the MVPN packet across the network via a MVPN tunnel.

In one embodiment of the present invention, a method of receiving packets of data is described. The method comprises receiving a transmission data packet comprising a transmission header and a transmission payload. The transmission payload comprises an embedded data packet. The embedded data packet comprises a compressed header and a compressed payload. The method comprises extracting the transmission payload from the transmission header; performing header decompression on the embedded data packet header and payload decompression on the embedded data packet payload.

In one embodiment of the present invention, a method of receiving data packets is described. The method comprises receiving at least one MIP data packet, transmitted via a MIP tunnel; extracting a VPN data packet from the at least one MIP data packet, the VPN data packet comprising a compressed header and a compressed payload; performing header decompression on the VPN header; performing payload decompression on the VPN payload; and extracting a TCP/IP data packet from the VPN data packet.

In one embodiment of the present invention, a method of receiving data packets is described. The method comprises receiving at least one MVPN data packet, transmitted via a MVPN tunnel; extracting a TCP/IP data packet from the at least one MVPN data packet, the TCP/IP data packet comprising a compressed header and compressed payload; performing header decompression on the TCP/IP header; and performing payload decompression on the TCP/IP payload.

In one embodiment of the present invention, apparatus is described having logic adapted to perform the aforementioned data packet compression and decompression steps.

In one embodiment of the present invention, a communication network is described adapted to support the aforementioned data packet compression and decompression steps.

Referring now to FIG. 2, there is illustrated a MIP data packet 200 according to an embodiment of the present invention.

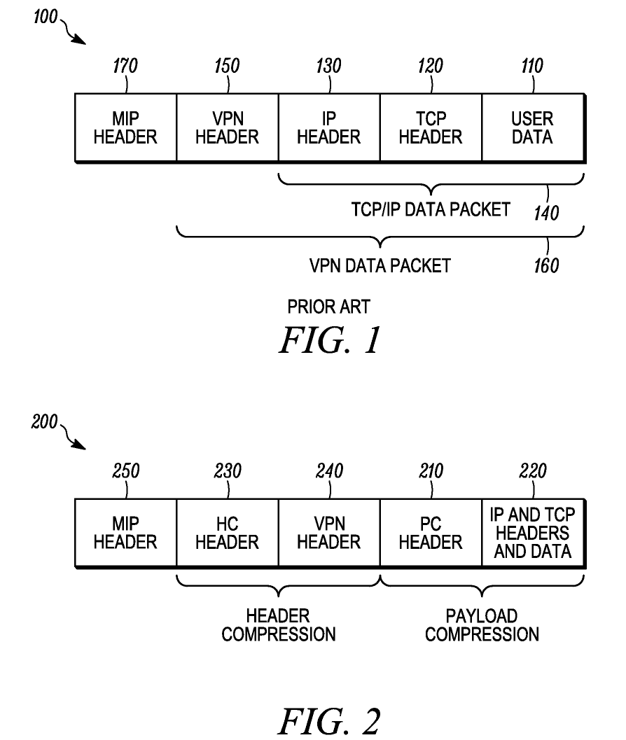

In this embodiment of the present invention, the user data has been encapsulated within a TCP header, and then encapsulated within an IP header, to create a TCP/IP packet. The TCP/IP data packet is then encapsulated within a VPN header, to create a VPN data packet, as is the case with the known MIP data packet 100 of FIG. 1.

However, payload compression is then performed on the payload of the VPN data packet, which is effectively the TCP/IP data packet containing the user data. This creates a payload compression (PC) header 210 and payload compressed data 220, where the payload compressed data 220 contains the TCP/IP data packet.

Header compression is subsequently performed on the VPN header. This creates a header compressed (HC) header 230 and header compressed data 240, the header compressed data 240 containing the VPN header.

The dual compressed VPN data packet is then encapsulated within a MIP header 250 to create the MIP data packet 200.

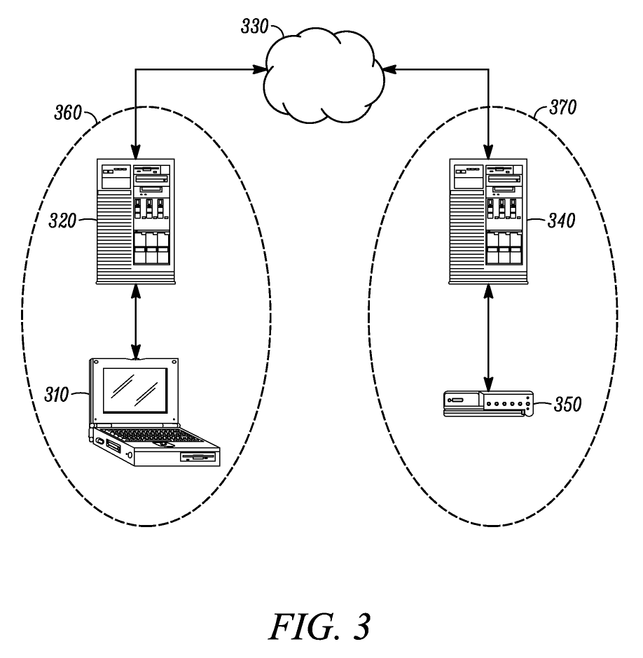

Referring now to FIG. 3, there is illustrated an exemplary embodiment of a mobile device connecting to a remote server, or other target device, via the Internet or other public telecommunication infrastructure (PTI).

The mobile device 310 comprises logic and/or processing circuitry (not shown) adapted to perform data packet compression and/or decompression steps as herein described. The mobile device 310 is connected to a foreign agent (FA) 320, which forms a part of a foreign network 360. The connection between the mobile device 310 and the FA 320 maybe wired or wireless, for example via Bluetooth (www.bluetooth.org), wireless local area network (WLAN)(IEEE standard 802.11 www.ieee.org), general packet radio system (GPRS) (www.3gpp.org), UMTS/3G (www.3gpp.org), etc. These wireless protocols are well known in the art, and are therefore not described in detail herein.

The FA 320 comprises a MIP client (MIP-C) (not shown), and provides a connection to a PTI 330, such as the Internet, which in turn provides a connection to a home agent (HA) 340. The HA 340 comprises a MIP gateway (MIP-GW) (not shown), and is connected to the target server 350. The HA 340 and the target server 350 form a part of a home network 370 for the mobile device 310. Hereafter, the term MIP component may be understood as encompassing a MIP-C or MIP-GW.

When the mobile device 310 leaves the home network 370, with which it is associated, and enters the domain of a foreign network, such as the foreign network 360, the MIP-C of the FA 320 uses the MIP tunnelling protocol to inform the MIP-GW of the HA 340 of a care-of-address to which all data packets for the mobile device 310 should thereafter be sent.

This is achieved by way of the MIP-GW routing messages via the PTI 330 to the MIP-C via tunnelling the original IP address of the mobile device 310 inside a MIP packet destined for the temporary IP address assigned to the mobile device 310 by the FA 320.

As previously mentioned, the MIP protocol allows mobile devices whose IP addresses are associated with one network to stay connected when moving to a network with a different IP address.

In order to provide data confidentiality, authentication, etc., it is necessary for a VPN to also be provided between the mobile device 310 and the target server 350.

Consequently, the FA 320 further comprises a VPN client (VPN-C) (not shown), and the HA 340 further comprises a VPN gateway (VPN-GW) (not shown). Data to be transmitted from the target server 350 to the mobile device 310 is encrypted and then encapsulated within a VPN header by the VPN-GW to create a VPN data packet. The VPN data packet is then routed to the mobile device 310 via the MIP-GW. In this way, the original data is effectively routed within a VPN tunnel, the VPN tunnel being nested within the MIP tunnel.

In the same way, when the mobile device 310 sends data, etc. to the target server 350, the VPN-C routes the data via a VPN tunnel, which the MIP-C nests through MIP tunnel.

The remote device 310 and the target server 350 encapsulate data within TCP/IP packets, which are then sent to the FA 320 and HA 340 respectively. Thus, data being transmitted is first encapsulated within a TCP/IP header, then encapsulated within a VPN header, and finally encapsulated within a MIP header.

According to an embodiment of the present invention, payload compression is then performed on the payload of the VPN data packet. Header compression is subsequently performed on the VPN header. The dual compressed VPN data packet is then encapsulated within a MIP header to create the MIP data packet.

In a first embodiment of the present invention, this dual compression is performed by the VPN-C or VPN-GW, depending on which direction the data is being sent. The dual compressed VPN packet is then provided to the MIP-C or MIP-GW, as appropriate.

In an alternative embodiment of the present invention, the FA 320 and/or HA 340 may further comprise a separate compressor component. In this way, the VPN-C and/or VPN-GW, as appropriate, may pass the VPN data packet to the compressor component, which performs the dual compression before providing the compressed VPN packet to the MIP-C and/or MIP-GW as appropriate. In a yet further embodiment, the MIP-C and/or MIP-GW may perform the dual compression. In this way, the VPN-C and/or VPN-GW may pass the uncompressed VPN data packet to the MIP-C and/or MIP-GW. The MIP-C and/or MIP-GW then performs the dual compression before encapsulating the now compressed VPN data packet within a MIP header.

In a still further embodiment, the payload compression and the header compression may be performed by different components. For example the VPN-C/VPN-GW or a separate compression component may perform the payload compression, whilst a separate component or the MIP-C/MIP-GW may perform the header compression.

Conversely, in one embodiment of the present invention, when the MIP-C and/or MIP-GW receives a MIP data packet, the MIP-C and/or MIP-GW may extract the compressed VPN data packet from the MIP header, and may pass it to the VPN-C and/or VPN-GW, as appropriate.

The VPN-C and/or VPN-GW may then perform header decompression and payload decompression to recover the uncompressed VPN data packet. The VPN-C and/or VPN-GW may then extract the TCP/IP data packet from the VPN header, and pass the TCP/IP data packet to the remote device 310 or target server 350, as appropriate. In this way, the remote device 310 and target server 350 are not aware of the means by which the TCP/IP data packet has been transmitted.

As with the compression and transmission of data, in alternative embodiments of the present invention the header and payload decompression may alternatively be performed by a separate decompressor component (which may or may not also be a compressor component), or by the MIP-C/MIP-GW. Furthermore, the header decompression and payload decompression may be performed by different components.

In the embodiment illustrated in FIG. 3, the VPN-C and the MIP-C are located on a single device, namely the FA 320. However, it is within the contemplation of the present invention that the VPN-C may be located on a separate device to the MIP-C. In the same way, the VPN-GW may be located on a device separate to the MIP-GW.

Likewise, for those embodiments of the present invention in which there is a separate compressor/decompressor component, the compressor/decompressor component may be located on a separate device.

In one embodiment of the present invention, the VPN-C, VPN-GW, MIP-C and MIP-GW each comprise one or more software components provided on a server or the like. However, it is within the contemplation of the present invention that one or more of these components may be provided by hardware and/or firmware.

It is anticipated that not all data sent/received by the FA 320 and/or HA 340 will be compressed, or that data sent/received may be compressed using alternative methods. Consequently, in one embodiment of the present invention, the transmission header, which for the illustrated embodiment is the MIP header, may contain an indication as to the nature of the encapsulated payload. In this way, when a data packet is received, the MIP-C/MIP-GW and/or VPN-C/VPN-GW may be able to determine the appropriate action for retrieving the encapsulated data.

Thus, according to embodiments of the present invention, there is provided a method of transmitting packets of data across a network, such as the Internet or other PTI. The, or each, packet of data comprises a header and a payload, such as a VPN data packet. Payload compression may be performed on the payload of the data packet, and header compression may be performed on the header of the data packet. In one embodiment, the payload compression may be performed prior to the header compression.

The compressed data packet may then be encapsulated within a transmission header to create a transmission data packet, for example, a MIP data packet. The transmission data packet may then be transmitted across the network.

The dual compression of both payload compression and header compression optimises the compression of the data and encapsulating headers, providing a distinct improvement in comparison to using payload compression on its own, as is known in the art.

Furthermore, encapsulating the compressed data packet within a transmission header, overcomes the need for the receiver and transmitter to be located one link away, a problem encountered with header compression, since the transmission header allows for routing the data packet through a network.

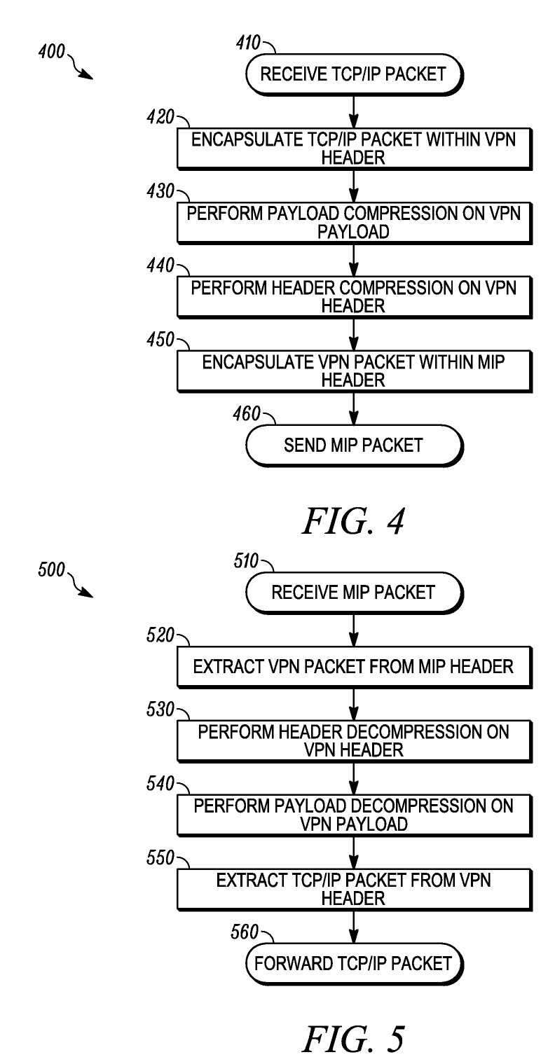

Referring now to FIG. 4, there is illustrated a flowchart of a method 400 of transmitting packets of data according to an embodiment of the present invention. The method starts with the step of receiving data to be transmitted 410, which for the illustrated embodiment is in the form of a TCP/IP packet. Next, the data is encapsulated within a header 420, which for the illustrated embodiment is a VPN header, creating a VPN data packet comprising a VPN header and payload.

A step 430 comprises performing payload compression on the payload of the created data packet. In step 440, header compression is performed on the header of the created data packet. The dual compressed data packet is then encapsulated in a transmission header, in step 450, which for the illustrated embodiment is a MIP header, creating a MIP data packet. Finally, in step 460, the MIP data packet is sent, for example, across the Internet.

Referring now to FIG. 5, there is a flow chart of a method 500 of receiving packets of data according to an embodiment of the present invention. The method starts with the step of receiving a transmission data packet 510, which for the illustrated embodiment is in the form of a MIP data packet. Next, an encapsulated data packet is extracted from the transmission data packet 520, which for the illustrated embodiment is in the form of a compressed VPN data packet.

A step 530 comprises performing header decompression on the header of the compressed VPN data packet. In step 540, payload decompression is performed on the payload of the compressed VPN data packet. The data, which for the illustrated embodiment is in the form of a TCP/IP data packet, is then extracted from the uncompressed VPN data packet 550. Finally, in step 560, the extracted data is forwarded to its destination address.

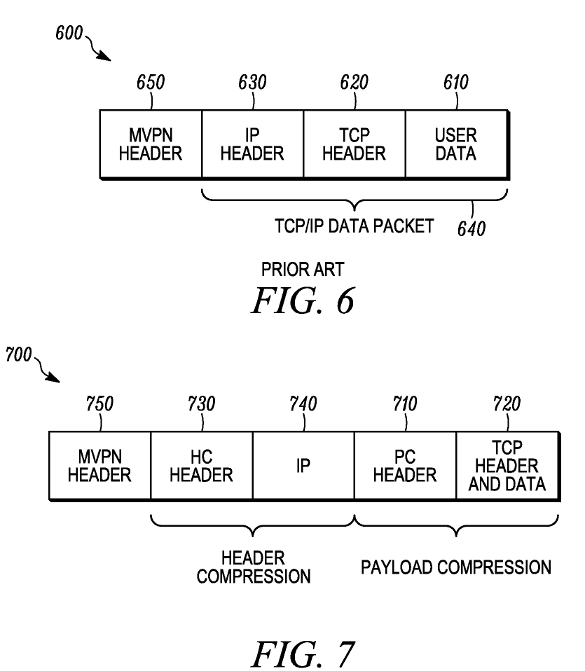

Referring now to FIG. 6 and FIG. 7, there is illustrated a further embodiment of the present invention.

FIG. 6 illustrates a prior art uncompressed Mobile VPN (MVPN) data packet 600. A MVPN data packet will be described in more detail below. However, for clarity, a MVPN provides a means for tunnelling data packets, in the same way as MIP and VPN data packets. In essence, a MVPN tunnel combines the ability of a MIP tunnel to allow a user to stay connected when moving to a foreign network, with the functionality of a VPN tunnel to provide confidentiality, integrity, etc.

In the same way as for the data packet of FIG. 1, the user data 610 has been encapsulated within a TCP header 620, and then encapsulated within an IP header 630, to create a TCP/IP data packet 640.

The TCP/IP data packet is then encapsulated within a MVPN data header 650 to create the uncompressed MVPN data packet 600.

Referring now to FIG. 7, there is illustrated a compressed MVPN data packet 700 according to an embodiment of the present invention. In this embodiment of the present invention, the user data has been encapsulated within a TCP header, and then encapsulated within an IP header, to create a TCP/IP data packet.

Payload compression is then performed on the payload of the TCP/IP data packet, which is effectively the TCP header and user data. This creates a payload compression (PC) header 710 and payload compressed data 720, the payload compressed data 720 containing the TCP header and user data.

Header compression is subsequently performed on the TCP/IP header. This creates a header compressed (HC) header 730 and header compressed data 740, the header compressed data 740 containing the IP header. The dual compressed TCP/IP data packet is then encapsulated within a MVPN header 750 to create the MVPN data packet 700.

Referring back to FIG. 3, for the embodiment of the present invention illustrated in FIGS. 6 and 7, the FA 320 comprises a MVPN client (MVPN-C) (not shown). The HA 340 comprises a MVPN gateway (MVPN-GW) (not shown).

When the mobile device 310 leaves the home network 370, with which it is associated, and enters the domain of a foreign network, such as the foreign network 360, the MVPN-C of the FA 320 informs the MVPN-GW of the HA 340 of a care-of-address to which all data packets for the mobile device 310 should thereafter be sent.

This is achieved by way of the MVPN-GW routing messages to the MVPN-C via tunnelling the original IP address of the mobile device 310 inside a MVPN packet destined for the temporary IP address assigned to the mobile device 310 by the FA 320.

As previously mentioned, the MVPN protocol allows mobile devices whose IP addresses are associated with one network to stay connected when moving to a network with a different IP address. In contrast to the MIP protocol, the MVPN protocol also provides for data confidentiality, authentication, etc, removing the necessity for a VPN to also be provided between the mobile device 310 and the target server 350.

Data to be transmitted from the target server 350 to the mobile device 310 is encrypted prior to being encapsulated within a MVPN header by the MVPN-GW. The MVPN data packet is then routed to the mobile device 310 via the MVPN-GW.

In the same way, when the mobile device 310 sends data, etc. to the target server 350, the MVPN-C encrypts the data and routes it via a MVPN tunnel.

In one embodiment of the present invention, the MVPN protocol follows the IPSec protocol for encryption etc. In this way, the MVPN data packet is able to provide the same benefits as a discrete VPN data packet in terms of confidentiality, integrity, etc.

When either the mobile device 310 or the target server 350 transmits data to the other, the data may be provided to the MVPN-C or MVPN-GW (as appropriate) in the form of one or more TCP/IP data packets.

In one embodiment of the present invention, the MVPN-C and MVPN-GW each comprise one or more software components provided on a server or the like. However, it is within the contemplation of the present invention that one or more of these components may be provided by hardware and/or firmware.

It is anticipated that not all data sent/received by the FA 320 and/or HA 340 will be compressed, or that data sent/received may be compressed using alternative methods. Consequently, in one embodiment of the present invention, the transmission header, namely the MVPN header, contains an indication as to the nature of the encapsulated payload.

As will be appreciated by a person skilled in the art, the use of an MVPN data header provides the additional advantage that only a single header is required to provide both mobility and confidentiality, integrity, etc. In this way, the overheads required for transmitting data across a network are reduced, allowing for increased throughput of the network.

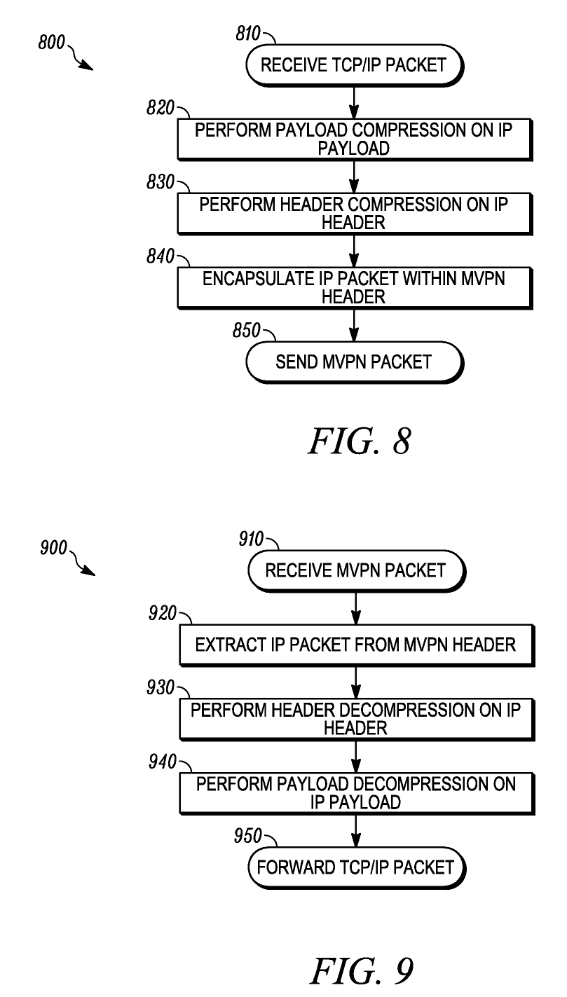

Referring now to FIG. 8, there is illustrated a flow chart of a method 800 of transmitting packets of data according to an embodiment of the present invention. The method starts with the step of receiving a data packet to be transmitted 810, which for the illustrated embodiment is in the form of a TCP/IP packet. A step 820 comprises performing payload compression on the payload of the received data packet.

In step 830, header compression is performed on the IP header of the received data packet. The dual compressed data packet is then encapsulated in a transmission header, in step 840, which for the illustrated embodiment is a MVPN header, creating a MVPN data packet. Finally, in step 850, the MVPN data packet is sent, for example, across the Internet.

Referring now to FIG. 9, there is a flow chart of a method 900 of receiving packets of data according to an embodiment of the present invention. The method starts with the step of receiving a transmission data packet 910, which for the illustrated embodiment is in the form of a MVPN data packet. Next, at a step 920, an encapsulated data packet is extracted from the transmission data packet, which for the illustrated embodiment is in the form of a compressed TCP/IP data packet.

A step 930 comprises performing header decompression on the IP header of the compressed TCP/IP data packet. In step 940, payload decompression is performed on the payload of the compressed TCP/IP data packet. Finally, in step 950, the extracted TCP/IP data packet is forwarded to its destination address.

As will be appreciated by a person skilled in the art, embodiments of the present invention provide at least the advantage of reducing the overheads required in transmitting data across a network, and therefore provides an improvement in throughput of a communication network.

It will be appreciated that any suitable distribution of functionality between different functional units may be used without detracting from the inventive concept herein described. Hence, references to specific functional devices or elements or computing units are only to be seen as references to suitable means for providing the described functionality, rather than indicative of a strict logical or physical structure or organization. Furthermore, the various components within these elements or devices can be realised in discrete or integrated component form, with an ultimate structure therefore being merely an application-specific selection.

Aspects of the invention may be implemented in any suitable form including hardware, software, firmware or any combination of these. The elements and components of an embodiment of the invention may be physically, functionally and logically implemented in any suitable way. Indeed, the functionality may be implemented in a single unit or integrated circuit (IC), in a plurality of units or ICs or as part of other functional units.

In particular, it is envisaged that the aforementioned inventive concept can be applied by a semiconductor manufacturer to any microprocessor capable of handling data packets, as described above.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to “a”, “an”, “first”, “second” etc. do not preclude a plurality.

Thus, an improved method, apparatus and communication network for the transmission of data has been described wherein the aforementioned disadvantages associated with prior art arrangements have been substantially alleviated.

1. A method of transmitting data across a network to or from a mobile terminal, the data including at least one data packet of data comprising a header and a payload, the method comprising:
encapsulating the data packet as an inner packet within an intermediate header to form an intermediate data packet comprising the intermediate header and the inner packet;
performing payload compression on the header and the payload of the inner packet to form a payload compressed inner data packet;
performing header compression on the intermediate header to form a header compressed intermediate header;
encapsulating within a transmission header a compressed intermediate data packet comprising the payload compressed inner data packet and the header compressed intermediate header to form a transmission data packet; and
transmitting the transmission data packet across the network to or from the mobile terminal.

2. The method of claim 19 wherein the payload compression of the inner data packet is performed prior to the header compression of the intermediate header.

3. (canceled)

4. (canceled)

5. (canceled)

6. A method of receiving data which has been sent across a network to or from a mobile terminal, the data including at least one data packet comprising a header and a payload, the method comprising:
extracting from a transmission data packet which has been transmitted across the network a compressed intermediate data packet comprising a payload compressed inner data packet and a header compressed intermediate header;
performing header decompression on the compressed intermediate header to form an intermediate header;
performing payload decompression on the compressed inner data packet to form an inner data packet comprising a header and a payload;
extracting the inner data packet from the intermediate header; and
forwarding the inner data packet to its destination address indicated by its header.

7. (canceled)

8. (canceled)

9. (canceled)

10. (canceled)

11. (canceled)

12. (canceled)

13. (canceled)

14. (canceled)

15. The method of claim 1 wherein the transmission header includes an indication of the nature of the data encapsulated within the transmission data packet to enable a receiver of the transmitted data packet to determine appropriate action for retrieving the encapsulated data.

16. The method of claim 1 wherein a plurality of the compression steps are performed by a single compressor.

17. The method of claim 1 wherein the inner data packet is an Internet Protocol/Transmission Communication Protocol (IP/TCP) data packet, the intermediate data packet is a Virtual Private Network (VPN) data packet, the transmission data packet is a Mobile Internet Protocol (MIP) or Mobile Virtual Private Network (MVPN) data packet, and the transmission step includes transmitting the transmission data packet via a MIP or MVPN tunnel.

18. The method of claim 17 wherein the VPN data packet is an IPSec data packet.

19. The method of claim 1 wherein the payload compression of the inner data packet and the header compression of the intermediate header are performed separately.

20. The method of claim 6 including the transmission data packet having a transmission header including an indication of the nature of the data encapsulated within the transmission data packet and a receiver of the transmitted data packet using the indication to determine appropriate action for retrieving the encapsulated data.

21. The method of claim 6 wherein a plurality of the decompression steps are performed by a single decompressor.

22. The method of claim 6 wherein the payload decompression of the compressed inner data packet and the header decompression of the compressed intermediate header are performed separately.

23. The method of claim 6 wherein the inner data packet is an Internet Protocol/Transmission Communication Protocol (IP/TCP) data packet, the intermediate data packet is a Virtual Private Network (VPN) data packet, the transmission data packet is a Mobile Internet Protocol (MIP) or Mobile Virtual Private Network (MVPN) data packet, and the method includes receiving the transmission data packet via a MIP or MVPN tunnel.

24. The method of claim 23 wherein the VPN data packet is an IPSec data packet.

25. The method of claim 24 wherein the payload decompression of the compressed inner data packet is performed after the header decompression of the compressed intermediate header.
